(19) United States
(12) Patent Application Publication
(10) Pub. No.: US 2019/0226934 A1
(43) Pub. Date: Jul. 25, 2019

(54) Tire Pressure Valve

(71) Applicants: Jason Zaldana, Hackensack, NJ (US); Gary Zaldana, Hackensack, NJ (US)

(72) Inventors: Jason Zaldana, Hackensack, NJ (US); Gary Zaldana, Hackensack, NJ (US)

(21) Appl. No.: 16/035,213

(22) Filed: Jul. 13, 2018

Related U.S. Application Data
(60) Provisional application No. 62/523,373, filed on Jun. 22, 2017.

(51) Int. Cl. G01L 17/00

(52) U.S. Cl. CPC G01L 17/005

(57) ABSTRACT

A tire valve system allowing a user to virtually check a vehicle's tire pressure and tire temperature remotely.

### CROSS-REFERENCE TO RELATED APPLICATION

This application claims priority to U.S. Provisional Application No. 62/532,474 filed on Jul. 14, 2017, the disclosure of which, including any materials incorporated by reference therein, is incorporated herein by reference in its entirety.

### TECHNICAL FIELD

The present invention relates generally to vehicles, and more specifically, an apparatus allowing one to virtual check a vehicle's tire pressure and tire temperature remotely.

### BACKGROUND

many drivers working in the trucking industry are under enormous time constraints. A commercial truck driver must be able to deliver the goods they are carrying on time so that they can get paid. One of the many variables a commercial truck driver has to ensure is under to control to meet the delivery demands is the commercial vehicle's tires. Due to varying weather temperatures, a tire may become damaged if not checked regularly. If the temperature is too low, the sidewall of the tire can be damaged which can lead to an explosion. If the temperature is too high, the tire may become weakened.

Attempts have been made, although unsuccessfully, to meet this need. One illustrative attempt can be seen with respect to U.S. Pat. No. 5,289,160 A, which generally discloses tire pressure monitoring system to warn a driver of low tire pressure. This discloser does not, however, address the issue of monitoring the temperature of a vehicle's tire. Therefore, a new means is needed to forewarn drivers of potential tire problems without having to take the time to check each tire manually.

Another attempt to meet this need can be seen with respect to U.S. Pat. No. 9,481,216, which generally discloses a tire pressure sensor module with Bluetooth capabilities for the purposes of communicating with a mobile app. While this disclosure does provide for a means for monitoring the pressure and temperature of a vehicle's tire remotely, it does not disclose a tire pressure system that transmits information regarding the condition or potential issue with a vehicle's tire prior to the event occurring.

As can be seen, various attempts have been made to solve the problems which may be found in the related art but have been unsuccessful. A need exists for a new apparatus and means to virtually monitor a vehicle's tire pressure and temperature.

### SUMMARY OF THE INVENTION

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

Furthermore, all elements listed by name, such as a “pressure,” “temperature,” and so forth, are herein meant to include or encompass all equivalents for such elements. For example, in addition to a “temperature,” the external temperature as well as the internal temperature is also contemplated by the present invention. Such equivalents are contemplated for each element named in its particular herein.

The present invention relates to a tire pressure sensor overcomes the deficiencies of the prior art. It is contemplated that the present invention may provide a tire pressure sensor apparatus that enables a user to monitor a vehicle's tire pressure and temperature remotely.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention provides a novel solution for a virtual tire pressure sensor apparatus. The general purpose of the present invention, which shall be described subsequently in greater detail, is to enable a user to remotely monitor a vehicle's tire pressure and temperature. The features of the invention are believed to be novel and to have been particularly pointed out and distinctly claimed in the concluding portion of the specification. These and other features, aspects, and advantages of the present invention will become better understood with reference to the following drawing and detailed description.

In a preferred embodiment of the present invention, the external end of the valve stem member contains a threaded screw insert while the opposite external end contains an inner sensor compartment to measure a vehicle tire's PSI pressure. The external end of the tire pressure valve also contains a rubber sealant to seal the sensor compartment in place and to prevent any the tire from releasing air pressure.

In a preferred embodiment of the present invention, the tire pressure valve would be installed through the standard valve hole on the rim of the tires. The user would insert the valve stem member through the valve hole and secure the tire pressure valve in place by tightening the threaded screw insert. Following installation, the tire may be mounted on the rim and filled with the appropriate air pressure, depending on the size of the tire.

In another preferred embodiment of the present invention, the user will be able to monitor the tire pressure and condition of up to 18 tires of one vehicle. To initiate the tire monitoring system disclosed by the present invention, the user would be required to identify the size, tire manufacturer, and/or whether the tire is a retreaded tire or a new (virgin) tire. The tire specifications for pre-selected tire manufactures automatically populate into the mobile app. Once in use, the mobile app's communication module will notify the user of the recommended tire pressure and road use temperature. If there are any changes in tire pressure or temperature, the mobile app's communication app will inform the user through an alert system, that air needs to be added to or removed from the vehicle's tire. This information can be accessed and reviewed remotely even when the user is away from the vehicle.

In yet another preferred embodiment of the present invention, the inner sensor compartment also contains a GPS tracking device that allows one to monitor the location of the vehicle through the mobile app.

The unique features of the present invention may provide the following benefits for one or more consumers: an automatic tire valve with a built-in PSI sensor, linked to a smartphone application, to warn drivers of potential problems with vehicle tires, help drivers save valuable time when doing mandatory vehicle inspection and to prevent tire blowouts while driving, help to extend the life of each tire by warning drivers with pressure issues, eliminates the need to do manual inspections, provide drivers with information concerning the external temperature as well as the internal temperature, allows drivers to focus on driving safely.

### BRIEF DESCRIPTION OF THE DRAWINGS

These and other features, aspects and advantages of the present invention will become better understood with regard to the following description, appended claims, and accompanying figures where:

FIG. 1 shows a perspective view of a tire pressure sensor in accordance with one embodiment of the invention.

FIG. 2 shows a side view of a tire pressure sensor in accordance with one embodiment of the invention.

FIG. 3 shows an additional right-side perspective view of a tire pressure sensor in accordance with one embodiment of the invention.

FIG. 4 shows a front view of a tire pressure sensor in accordance with one embodiment of the invention.

### DETAILED DESCRIPTION

The present invention overcomes the limitations of the prior art by providing a new and more effective tire pressure sensor.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known features, elements or techniques may not be shown in detail in order not to obscure the embodiments.

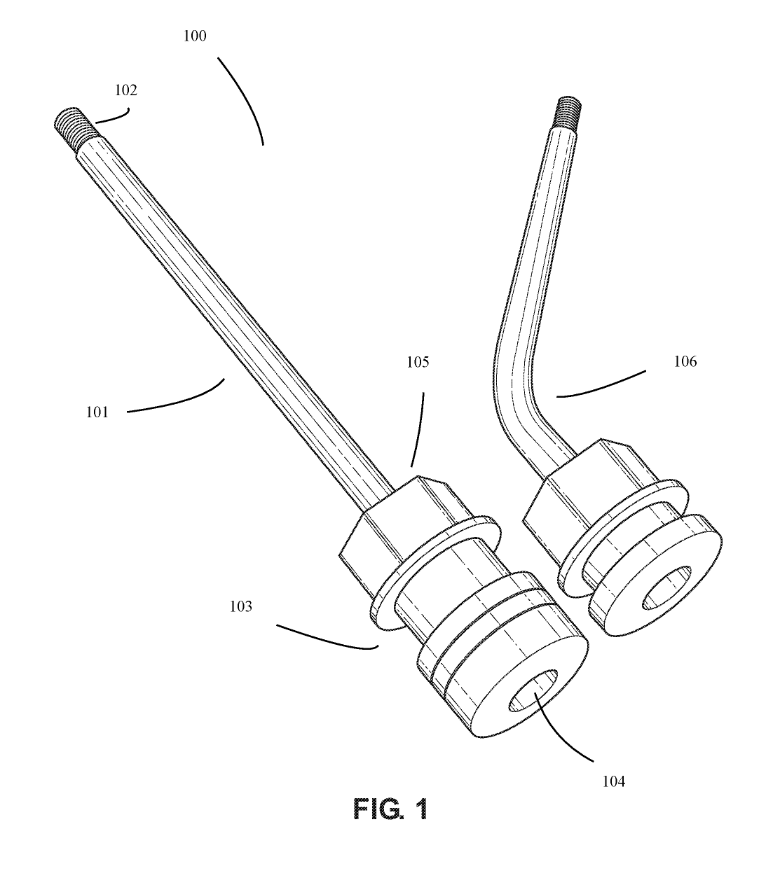

Turning attention to FIG. 1, a perspective view of a tire pressure sensor in accordance with one embodiment of the invention is shown. In the embodiment depicted, a viewer may perceive a tire pressure sensor 100 having a valve stem member 101 with a threaded screw insert 102 on one end and an external end 103 containing an inner sensor 104 compartment to measure a vehicle tire's PSI pressure and temperature. The external end 103 of the tire pressure sensor 100 contains a rubber sealant 105 to seal the sensor compartment 104 in place and to prevent any the tire from releasing air pressure. In an alternative embodiment, the tire pressure sensor may have a curved valve stem member 106.

Although designated as “cylindrical,” external end 103 may also be of any shape, weight, or other properties known in the art. For example, the external end 103 may be in the shape of a square, rectangle, oval or circle, may have the thickness of a few millimeters to an inch, and may be composed of a material or combination of materials of plastic, metal, or ceramic nature.

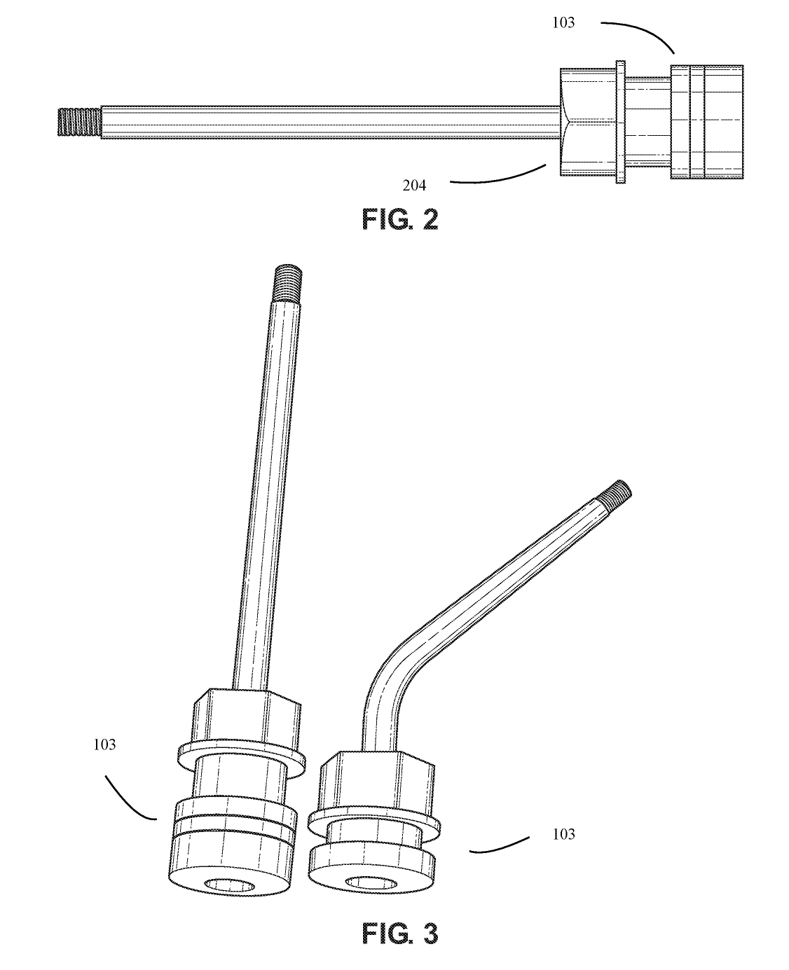

With respect to FIG. 2 a side perspective view of a tire pressure sensor in accordance with one embodiment of the invention is shown. In the embodiment depicted, a viewer may perceive the composition of the external end 103 having a seal 201 and a body chamber 202.

The body chamber 202 comprises of internal features (not shown) to allow for the monitoring and of the tire pressure and temperature, inclusive of a circuit, a pressure sensor, a temperature sensor, inclusive of external temperatures, a battery, a transceiver, GPS, and wireless communication features such as Bluetooth 203.

Additionally, in FIG. 2, a viewer may perceive that the external end 103 of the tire pressure valve 100 also contains a rubber sealant 204 to seal the sensor compartment in place and to prevent any the tire from releasing air pressure.

With respect to FIG. 3, an additional perspective view of a tire pressure sensor 100 in accordance with one embodiment of the invention is shown. In the embodiment depicted, a viewer may perceive varying heights, widths, and diameters of the external end 103.

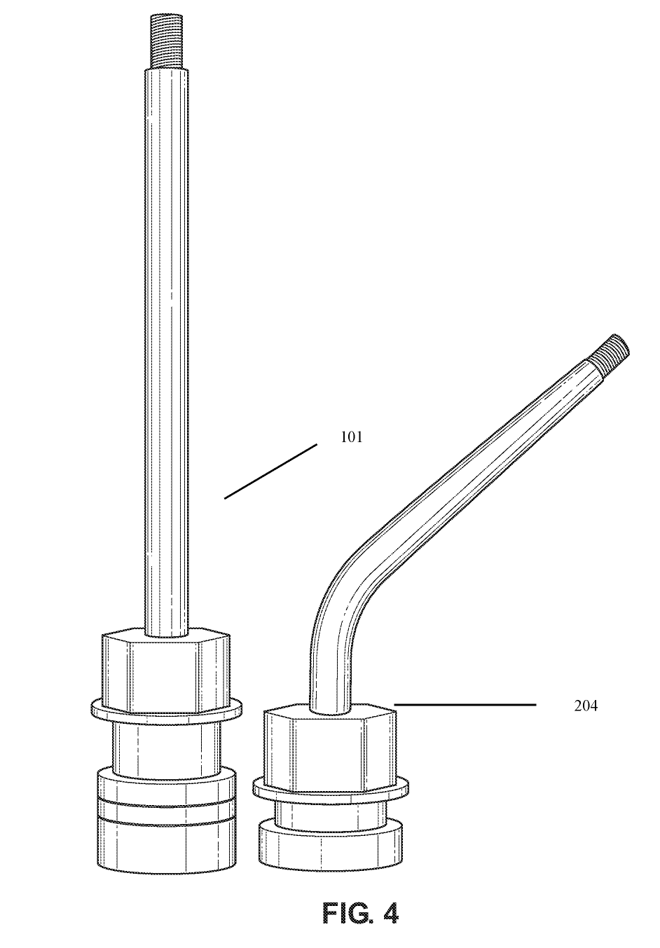

With respect to FIG. 4, a front view of a tire pressure sensor in accordance with one embodiment of the invention is shown. A viewer may perceive that the valve stem member 101 is perpendicular to the rubber sealant 204 of the external end 103.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the tire pressure sensor generally described herein has been disclosed in connection with a number of embodiments shown and described in detail, various modifications should be readily apparent to those of skill in the art.

What is claimed is:

1. A tire pressure sensor comprising
a valve stem member insert and
an external end.

2. A tire pressure sensor of claim 1, wherein the valve stem member has a threaded screw insert.

3. A tire pressure sensor of claim 1, wherein the external end comprises a body chamber having body chamber a circuit, a pressure sensor, a temperature sensor, inclusive of external temperatures, a battery, a transceiver, GPS, and a wireless communication module.

4. A tire pressure sensor of claim 3, wherein the communication module collects and transmits information to a mobile device or computer.

5. A tire pressure sensor of claim 3 where the communication module is capable of transmitting information to an iOS, Android, or Windows operating system.
